(19) United States
(12) Patent Application Publication
(10) Pub. No.: US 2005/0092030 A1
(43) Pub. Date: May 5, 2005

(54) Method and apparatus for depositing glass soot

(76) Inventors: Jitendra Balakrishnan, Ithaca, NY (US); Dana C. Bookbinder, Corning, NY (US); Lisa C. Chacon, Corning, NY (US); Steven A. Dunwoody, Castle Hayne, NC (US); Kintu O. Early, Painted Post, NY (US); Daniel W. Hawtof, Corning, NY (US); Prantik Mazumder, Ithaca, NY (US); Amy L. Rovelstad, Ithaca, NY (US); Susan L. Schiefelbein, Ithaca, NY (US); Pushkar Tandon, Corning, NY (US)

Correspondence Address: Kevin M. Able;Corning Incorporated, SP-TI-3-1, Corning, NY, 14831, US

(21) Appl. No.: 10/699,446

(22) Filed: Oct. 31, 2003

(51) Int. Cl. C03B 37/018

(52) U.S. Cl. 65/421

(57) ABSTRACT

The invention includes methods and apparatus for depositing soot onto a glass surface to minimize water in the deposited soot and the diffusion of the water into the glass surface. The invention includes depositing a first layer of soot a on the glass surface at a first forward traverse rate and depositing a second layer of soot at a second forward traverse rate.

### BACKGROUND OF THE INVENTION

1. Field of the Invention

The present invention relates generally to a method and apparatus for depositing glass soot, and more particularly, to a method and apparatus for making an optical fiber preform.

2. Technical Background

Water in an optical fiber is a source of undesirable attenuation of a light signal propagating along the fiber. Water as used here includes H₂O, OH, or H molecules. The silica (SiO₂) can react with one of the above forms of water (H₂O, OH, or H) to form SiOH. The SiOH group absorbs light strongly at 1380 nm and causes the aforementioned attenuation. The SiOH group in the optical fiber may degrade not only the attenuation performance of optical fibers operating in the 1310 nm window, but may also increase the attenuation of optical fibers operating at wavelengths as long as 1510 nm.

Prior attempts to remove water from the optical fiber include drying soot regions of the optical fiber preform with a halide gas (such as Cl gas, for example) prior to consolidating the preform and drawing the optical fiber from the consolidated preform. Typically, the aforementioned drying takes place at temperatures of about 800-1200° C. The halide gas may be exposed to both an outer surface of the preform as well as a soot centerline of the preform.

However, in the course of manufacturing segmented core fibers using multi-step processes, the aforementioned drying process in some circumstances may be insufficient to reduce the SiOH concentration in the consolidated glass regions of the preform to an acceptable level.

In a modern conventional optical fiber manufacturing process, such as an outside vapor deposition process (OVD), optical fiber may be manufactured by first forming a core cane. In subsequent steps, additional glass is formed on the core cane to form a draw preform. The draw preform may then be drawn into an optical fiber. A multi-step manufacturing process advantageously provides significant manufacturing flexibility, as a core cane may form the basis for multiple optical fiber designs and is easily stored for subsequent use, as needed. In a multi-step process, one or more additional layers of glass may be formed on a core cane in one or more steps. The additional glass may be formed on the core cane by heating and collapsing one or more glass tubes over the core cane (sleeving), by depositing glass soot (deposition) onto the core cane and heating and consolidating the glass soot, or both sleeving and deposition/consolidation. The additional glass may include additional core glass, cladding glass, or both core and cladding glass.

When deposition is used to add glass within or adjacent to the core region of an optical fiber preform, the additional layers of soot may form multiple core segments. The refractive index of the segments may vary within each segment, or the refractive index may vary from one segment to another segment. A multi-step process, such as the one described supra, is particularly well-suited to the manufacture of such segmented core optical fibers, and is described in U.S. Pat. No. 4,453,961.

A circularly symmetric porous core preform may be formed in accordance with the outside vapor deposition (“OVD”) method illustrated in FIG. 1. In the embodiment shown in FIG. 1, an optical fiber core preform is formed by a method similar to that disclosed in U.S. Pat. No. 4,486,212 (Berkey). Referring to FIG. 1, the large diameter end of a tapered starting member, or mandrel 10, is inserted into glass tube 12, hereinafter referred to as handle 12, having annular protrusion 14. Protrusion 14 causes preform 20 to adhere to handle 12; handle 12 supports preform 20 during subsequent processing. Shims (not shown) can be used to secure handle 12 to mandrel 10 as disclosed in U.S. Pat. No. 4,289,517. The mandrel may be provided with a layer of carbon soot to facilitate removal of the soot preform. Mandrel 10 is rotated and translated as indicated by arrows 16, 18 with respect to single burner 20 such as the type disclosed in U.S. Pat. No. 4,165,223, for example. Fuel gas and oxygen or air are supplied to burner 20 from a source (not shown). This mixture is burned to produce a flame which is emitted from burner 20. A gas-vapor mixture is oxidized within the flame to form a soot stream 22 which is directed toward mandrel 10. Suitable methods for delivering the gas-vapor mixture to burner 20 are well known in the art; for an illustration of such methods reference is made to U.S. Pat. Nos. 3,826,560, 4,148,621 and 4,173,305. One or more auxiliary burners (not shown) may be employed to direct a flame toward one or both ends of the porous soot preform during deposition to prevent breakage; the use of auxiliary burners is taught in U.S. Pat. No. 4,810,276 (Gilliland).

Burner 20 is generally operated under conditions that will provide acceptably high deposition rates and efficiency while minimizing the buildup of soot on the face thereof. Under such conditions, the flow rates of gases and reactants from the burner orifices and the sizes and locations of such orifices as well as the axial orientation thereof are such that a well focused stream of soot 22 flows from burner 20 toward mandrel 10. In addition, a cylindrical shield (not shown) which is spaced a short distance from the burner face, protects soot stream 22 from ambient air currents and improves laminar flow. Porous soot core preform 24 is formed by traversing mandrel 10 many times with respect to burner 20 to cause a build-up of silica soot. The translating motion could also be achieved by moving burner 20 back and forth along rotating mandrel 10 or by the combined translational motion of both burner 20 and mandrel 10. Porous soot preform 24 may contain only core glass, or alternatively, the preform may contain core glass and at least a portion of the cladding glass. After the deposition of soot preform 24, mandrel 10 is pulled therefrom, and the mandrel is removed through handle 12, thereby leaving a longitudinal aperture 26 in the porous preform, as shown in FIG. 2, through which drying gas may be flowed. Typically, the drying gas is Cl₂. Optionally, SiCl₄ may also be used as a satisfactory drying gas.

Drying of porous preform 24 may be facilitated by inserting a short section of capillary tube 28 into that end of aperture 26 opposite handle 12 and placing preform 24 in a furnace. A drying gas is flowed through handle 12 into aperture 26 and out through capillary tube 28 as shown by arrow 30. Capillary tube 28 initially permits some of the drying gas to flush water from the central region of preform 24. As porous preform 24 is inserted into a consolidation furnace, the aperture of capillary tube 28 closes, thereby causing all drying gas to thereafter flow through the preform interstices as shown by arrow 32. The drying gas may also be introduced into the consolidation furnace such that the gases may penetrate preform 24 through the exterior surface of preform 24.

As the drying gas is flowing, consolidation of preform 24 is begun by driving the preform into the hot zone of the consolidation furnace. Examples of a suitable consolidation furnace are disclosed in U.S. Pats. Nos. 4,165,223 and 4,741,748. The scanning consolidation furnace disclosed in U.S. Pat. No. 4,741,748 is advantageous in that one source of heat in the preform is generated by a coil that scans along the preform. A sharp hot zone can be generated by slowly traversing the coil along the preform; alternatively, the preform can be isothermally heated by rapidly reciprocating the coil. Moreover, the temperature of a scanning consolidation furnace is readily adjustable.

After consolidation, preform aperture 26 will be closed at preform end 34, as shown in FIG. 3, due to the presence of the closed capillary plug. If no plug is employed the entire 26 aperture will remain open. In this event aperture 26 is closed at preform end 34 after consolidation by a technique such as heating and pinching the same.

Consolidated preform 36 of FIG. 3, which will form at least a portion of the core region of an optical fiber, is then stretched into an intermediate glass rod, or core cane as shown in FIG. 4, which is thereafter provided with additional glass as shown in FIG. 5.

The core cane may be formed in a conventional redraw furnace wherein the tip of consolidated preform 36 from which the core cane is being drawn is heated to a temperature which is slightly lower than the temperature to which the preform would be subjected to draw optical fiber therefrom. A temperature of about 1900° C. is suitable for a silica preform. A suitable method for forming a core cane is illustrated in FIG. 4. Consolidated preform 36 is mounted in a conventional redraw furnace suspended from movable yoke 38, within which handle 12 is seated, and wherein the tip of consolidated preform 36 is heated by heater 40. A vacuum connection 42 is connected to handle 12, and preform aperture 26 is evacuated as indicated by arrow 41. A glass rod 42, which is attached to the lower end of preform 36, is pulled by motor-driven tractors 44, thereby forming core cane 46. As core cane 46 is drawn, aperture 26 readily closes since the pressure therein is low relative to ambient pressure. The diameter of a typical core cane that is to be employed as a mandrel upon which additional soot is to be deposited is preferably in the range of 4 to 10 mm.

Once formed, a segment of core cane 46 may be mounted in a lathe where it is rotated and translated with respect to burner 20 as shown in FIG. 5 and similar to FIG. 1. A porous layer 48 of silica soot is built up on the surface of core cane 46 to form a composite preform 50, including core cane 46 and soot layer 48. Soot layer 48 may form additional core glass, or soot layer 48 may include at least a portion of the cladding glass. Composite preform 50 may be dried and consolidated by conventional methods. Preferably, the consolidated optical fiber preform may be drawn into an optical fiber.

The relative refractive index profile 52 of the core region 54 of an arbitrary and exemplary optical fiber is shown in FIG. 6. The term refractive index profile or simply index profile is the relation between A and radius over a selected portion of the core, where A is defined by the equation,
Δ=(nᵢ²−n_{c}²)/2nᵢ²,
and where nᵢ is the maximum refractive index of the index profile of segment i, and n_{c} is the refractive index in the reference region which is usually taken to be the minimum refractive index of the clad layer. The relative refractive index is generally expressed as a percent and is indicated herein by the term Δ %. Core region 54 in FIG. 6 includes at least one segment, but may include two, three, four or more segments. The optical fiber depicted in FIG. 6 has an updoped region, e.g., germanium doped region, 56. The fiber may optionally include a down doped region, e.g., doped with boron or fluorine, 58, an updoped (e.g., doped with germanium) ring region 60, and a down doped (e.g., doped with fluorine or boron) region 62. The core region 54 is followed by a cladding region 64. One preferred type of cladding is undoped silica soot. The core region 54 is not limited to any particular number of core segments except that the core region 54 has at least one segment.

It has previously been assumed that a significant source of water in an optical fiber resulting from a multi-step manufacturing process such as the one described supra, wherein one or more layers of glass soot are deposited onto a glass core cane, originated from incomplete drying of the soot regions of the composite optical fiber preform during subsequent steps to dry and consolidate the preform. It was believed that this residual water migrated to the core region of the preform during the consolidation heat treatment. However, it has been discovered by the inventors herein that a significant source of water which is incorporated into the glass core cane during the subsequent deposition of glass soot originates from the oxidation of the hydrogen-based fuels typically used to hydrolyze the glass soot precursors. The water thus formed may then be deposited on the surface of the core cane. Moreover, the inventors herein have also discovered that migration of the water into the core cane, resulting in rewetting of the core cane, is dependent upon certain process parameters during the deposition of soot onto the core cane. In particular, the localized temperature of various regions of the core cane and the time during which these localized regions are at a specific temperature play an important part in the amount of water which may be adsorbed. Water which may be adsorbed into the core cane in this manner may not be adequately removed from the preform during drying or consolidation of the preform, and may therefore remain in the drawn optical fiber. The adsorbed water may react with silica to form SiOH, which has a broadband absorption at about 1380 nm, and which in turn may result in an increased attenuation in an operating wavelength range, or window, used within the telecommunication industry.

### SUMMARY OF THE INVENTION

One embodiment of the invention includes a method for making an optical fiber preform including the steps of providing relative reciprocating motion between at least one soot producing burner and a consolidated glass rod, depositing a first layer of glass soot along a length of the consolidated glass rod at a first traverse rate in a first direction, and depositing a second layer of glass soot onto the first layer of glass soot at a second traverse rate in the first direction without sintering. Preferably, a thickness of the first layer of glass soot is at least about 5 mm, more preferably between about 5 mm and 20 mm.

Preferably, a traverse rate in a second direction is greater than the first traverse rate in the first direction. Preferably, the first traverse rate in the first direction is at least about 7 m/s, more preferably at least about 10 cm/s. Preferably, the traverse rate in the second direction is greater than the first traverse rate in the first direction. Preferably, a rate of deposition of glass soot in the second direction is substantially zero.

Another embodiment of the invention includes an apparatus for depositing soot onto a glass rod. The apparatus includes at least one soot deposition burner, a movable support for mounting a glass rod, and at least one damping device comprising a piston and a viscous fluid mounted for cooperation with the support and aligned to inhibit a movement of the support at a first turnaround point.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a partial cross sectional side view of a method of depositing glass soot.

FIG. 2 is a partial cross sectional side view of flowing drying gases through a porous preform.

FIG. 3 is a partial cross sectional side view of a consolidated optical fiber core preform containing a centerline hole.

FIG. 4 is a partial cross sectional side view of a method for drawing a glass rod, or core cane, from a consolidated core preform.

FIG. 5 a partial cross sectional side view of the deposition of glass soot onto a core cane.

FIG. 6 is a graph of the relative refractive index of an exemplary optical fiber in terms of Δ % and radius of the fiber.

FIG. 7 is a partial cross sectional side view of a soot deposition process using a single burner.

FIG. 8 is a partial cross sectional side view of a soot deposition process using two burners.

FIG. 9 is a partial cross sectional side view of a soot deposition process using a combination of a single burner and two burners

FIG. 10 is a top view of a soot deposition lathe employing damping elements at the turn around points.

FIG. 11 is a partial cross sectional side view of an exemplary damping device.

FIG. 12 is a plot of the surface temperature of the surface of a glass rod as a function of time for three different forward traverse rates.

FIG. 13 is a plot of the temperature envelope at the surface of a glass rod as a function of time during a deposition process.

FIG. 14 is a plot of the surface temperature a glass rod as a function of time for glass rods having two different diameters.

FIG. 15 is a plot of the amount of water contained in glass rods as a function of distance from the surface of the glass rod, for a soot deposition process.

FIG. 16 is a plot of the surface temperature of a glass rod as a function of time for a single burner and a double burner deposition process.

FIG. 17 is a plot of the temperature envelope at the surface of a glass rod as a function of time for a single burner and a double burner deposition process.

FIG. 18 is a plot of the concentration of water deposited at a glass-soot interface as a function of the thickness of soot deposited on the glass surface.

FIG. 19 is a plot of the comparison of the concentration of OH adsorbed into three core canes manufactured using different forward traverse rates.

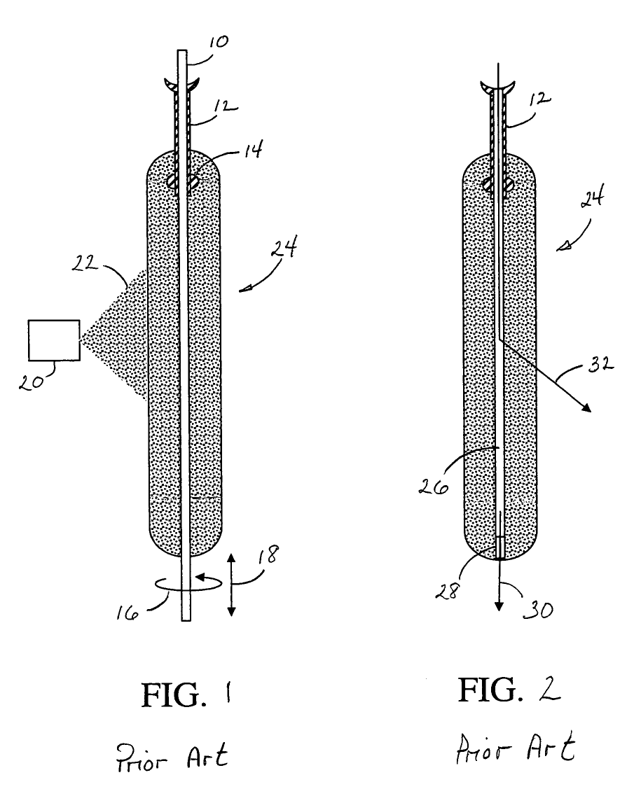

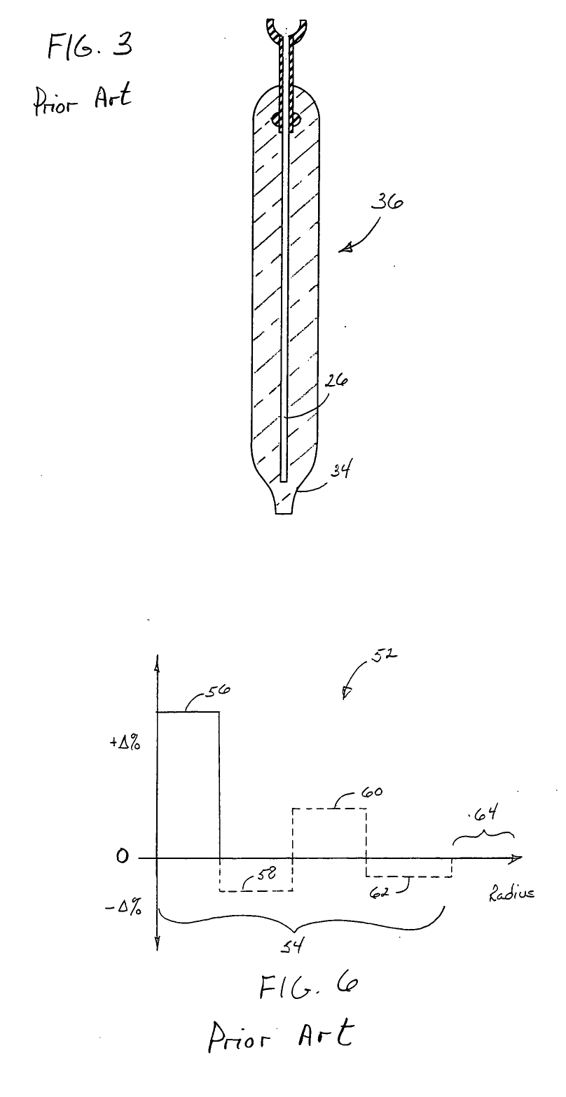

### DETAILED DESCRIPTION OF THE PREFERRED EMBODIMENTS

The present invention relates to methods and apparatus for depositing soot onto a glass surface. Preferably, the glass surface is a glass rod. The glass rod may be solid glass, or the glass rod may have an aperture disposed along the longitudinal axis of the glass rod. Preferably, the glass rod is a core cane. By core cane what is meant is a consolidated glass rod which includes at least a portion of the core glass of an optical fiber which will eventually be drawn from a preform using the core cane.

Rewetting of the core region of an optical fiber preform is a significant consideration in the manufacture of low loss optical fibers when employing the combustion of a hydrogen-containing fuel during the deposition process. Rewetting is an especially troublesome issue for the manufacture of optical fibers manufactured with a multi-step process, including, but not limited to, segmented core optical fibers. By multi-step process what is meant is a process of manufacturing an optical fiber preform wherein a glass rod, or core cane, is first made by a conventional process, and which core cane may serve as the target rod for a subsequent deposition of glass soot to form either a next segment of the core, or, optionally, cladding soot may be deposited onto the core cane. Because the predominant portion of the optical power propagating in a single mode optical fiber travels within the core region of the optical fiber, and the distribution of that power is heavily weighted toward the center of the core region, rewetting of the initial glass core rod may significantly affect the attenuation of the optical fiber by placing a high concentration of water in the region of the optical fiber having a high optical power level. Rewetting of the core cane by the deposition of glass soot onto the core cane may lead to a significant increase in optical loss of the resultant optical fiber. To minimize optical loss, or attenuation, in an optical fiber it is preferred that the amount of OH adsorbed into the surface of the glass core cane is minimized. For example, for a standard step index single-mode optical fiber, the water content of the core cane at the core-cane-soot interface should be less than about 7 ppm-μm (where ppm is by weight), preferably less than about 0.5 ppm-μm. In this context, the unit ppm-μm results from the measurement of OH as a function of radial distance across the radius of a glass surface. For example, measurements of OH concentration are taken at a plurality of locations across the radius of a glass rod using Fourier Transform Infrared Spectroscopy (FTIR). The measurement of OH concentration in glass by FTIR is well known. However, in the present instance, the data is plotted as a function of radial position. The area under the curve of the plot is then represented as a value in ppm-μm. The significance of this method of characterization is that the importance of the OH content to attenuation is a function not only of the peak amount of OH present at the glass surface, or interface, but also the radial extent of the concentration. By interface what is meant is a region extending about 100 μm from the surface of the core cane into the interfacial materials, e.g. the core cane and a first soot layer (or consolidated overclad layer). Assuming a draw-down ratio of about 1000, this upper limit for water in the present example translates into a concentration of OH in the standard single mode optical fiber drawn using the core cane preferably less than about 0.0005 ppm-μm at the core cane-overclad interface, more preferably less than about 0.007 ppm-μm. Overclad refers to the total amount of cladding glass material added to the core cane to complete the optical fiber preform.

Surprisingly, although the concentration of water vapor at the glass-soot interface during the deposition of soot onto the glass rod may be significant, it is the temperature at the glass surface that exerts the greatest influence over the amount of water adsorbed into the glass. Thus, controlling the glass surface temperature becomes a principal consideration during the deposition process. It has also been discovered by the inventors herein that, due to the low thermal conductivity of glass soot, a relatively thin layer of glass soot deposited on the surface of the core cane is capable of insulating the core cane, thereby reducing the surface temperature of the core cane and limiting the adsorption rate of water which may exist at the core cane-glass soot interface into the core cane.

One method that may be employed to decrease the manufacturing cost of an optical fiber preform is to increase the deposition rate of glass soot. Achieving an increased deposition rate has lead to widespread use of multiple soot-producing burners. Although the use of multiple burners to deposit glass soot has produced the desired increases in deposition rates, the high temperature produced at the surface of the glass core cane may undesirably increase the amount of water adsorbed into the glass. Single burner deposition, although typically employing a similar flame temperature as multiple burner deposition, tends to produce a lower surface temperature than multiple-burner deposition. As a single burner flame traverses the length of a glass rod, the localized surface of the rod adjacent the burner flame experiences a period of time between passes of the flame where it cools. The cooling reduces the adsorption of water into the surface of the core cane. The reciprocating relative motion between the burner and the core cane produces a periodic heating and cooling cycle which forms an envelope representing the overall temperature of the glass rod as a function of time. The temperature envelope for a single burner deposition process is typically lower than the temperature envelope for a multiple bunrer deposition process.

Nevertheless, rewetting of the core cane may be further reduced, even in the case of single-burner deposition, by increasing the relative traverse rate of the burner. Such an increase in the burner relative traverse rate may be augmented by the deposition of an insulating layer of glass soot during a period of increased traverse rate, followed by the deposition of additional soot during a subsequent, lower traverse rate.

In the case of multiple burners, there may be insufficient time between the traverse of the first burner past a point on the surface of the glass rod and the traverse of the second burner past the same point on the glass rod for the glass surface of the rod at that point to cool a sufficient amount to reduce the amount of water adsorbed into the glass. Although a small amount of cooling may occur after the first burner passes a given point on the glass surface, the surface of the glass rod does not reach the minimum temperature which may be achieved with a single burner. Passage of the second burner therefore drives the peak surface temperature higher than the temperature otherwise achieved with a single burner. Rewetting of the core cane may be reduced by depositing an insulating layer of glass soot on the glass rod at a first traverse rate, followed by the deposition of additional glass soot on the first layer of glass soot at a second, slower traverse rate. Sintering of either the first or second layer of soot is not performed during deposition of the second glass soot layer. Deposition of the first, insulating layer of soot may be performed with a single burner, whereas a subsequent deposition of additional soot may thereafter be deposited using multiple burners.

In accordance with a first embodiment of the invention, a method is provided for making an optical fiber preform. The method includes the step of depositing soot onto the surface of a consolidated glass rod or core cane. The glass rod may either be doped or undoped silica based glass. Potential dopants include at least F, B, Ge, Er, Ti, Al, Li, K, Rb, Cs, Cl, Br, Na, Nd, Bi, Sb, Yb and combinations thereof. The glass rod may be formed by any type of chemical vapor deposition (“CVD”) technique, such as outside vapor deposition (“OVD”), vapor axial deposition (“VAD”), modified chemical vapor deposition (“MCVD”), and plasma chemical vapor deposition (“PCVD”). Optionally, the deposited soot may be undoped silica, or the soot may be doped. A list of potential dopants is the same as the above.

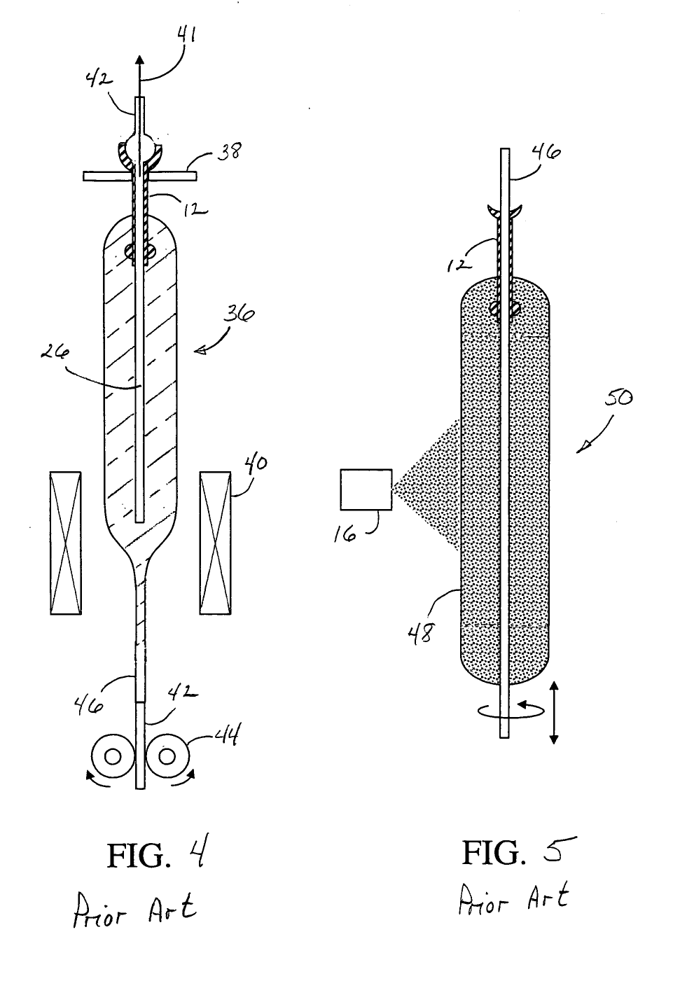

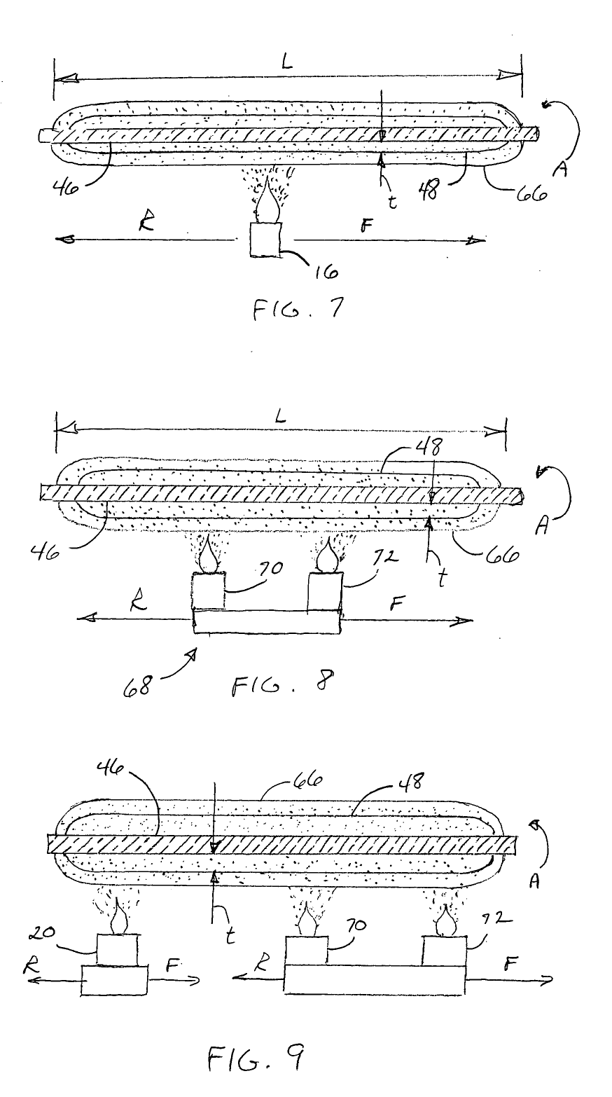

FIG. 7 depicts the deposition of soot layer 48 onto a glass core cane 46 by a single soot burner 20. Glass core cane 46 may rotate in the direction of arrow A or in a direction counter to arrow A. Preferably, burner 20 traverses along at least a portion of length L of core cane 46 in the forward direction as indicated by arrow F and the reverse direction as indicated by arrow R. Preferably, burner 20 traverses along substantially all of length L of core cane 46 in the forward direction as indicated by arrow F and the reverse direction as indicated by arrow R. Burner 20 traverses along length L of core cane 46 at a first forward traverse rate greater than conventional rates of between about 3 cm/s and 6 cm/s. Preferably, the first forward traverse rate is at least about 7 cm/s, preferably at least about 10 cm/s, more preferably yet at least about 20 cm/s, even more preferably at least about 30 cm/s, and most preferably at least about 40 cm/s. In some embodiments, the first forward traverse rate may be as high as about 100 cm/s. Alternatively, burner 20 may be stationary while core cane 46 traverses along a path parallel to the longitudinal axis of the core cane and adjacent to the burner 20. In yet another optional configuration, both burner 20 and core cane 46 may move to create a relative reciprocating motion.

Preferably, the reverse traverse rate in direction R is greater than the forward traverse rate in direction F. For example, if the forward traverse rate is at least about 10 cm/s, the reverse traverse rate may be at least about 15 cm/s. If the forward traverse rate is about 45 cm/s, the reverse traverse rate is at least about 47 cm/s. In accordance with a preferred embodiment, the reverse traverse rate is at least about 50 cm/s.

According to further embodiments, a first forward traverse rate is used to deposit a first soot layer 48 on core cane 46 that has a thickness t of at least about 5 mm, more preferably at least about 7 mm, and even more preferably at least about 10 mm. Preferably, soot layer 48 includes a thickness of no more than about 20 mm of soot. The preferred traverse rates for depositing soot layer 48 are as heretofore described.

If, once soot region 48 has been deposited onto cane 46 and if additional soot 66 is desired to be deposited, it is preferred that the additional soot layer 66 is deposited at a second forward traverse rate. Preferably, the additional soot layer 66 is deposited on the first, insulating soot layer 48 without sintering either soot layer 48 or soot layer 66. Preferably, the second forward traverse rate used to deposit soot layer 66 is less than the first forward traverse rate used to deposit soot layer 48. For example, the additional soot layer 66 may be deposited over top of the first soot layer 48 at a second forward traverse rate of less than about 7 cm/s.

In still another embodiment, multiple glass soot producing burners are used to deposit glass soot onto a consolidated glass rod, as shown in FIG. 8. FIG. 8 is the same as FIG. 7 except that in FIG. 8 dual soot burners are used to deposit soot instead of a single soot burner 16 as depicted in FIG. 7. Burner apparatus 68 includes two soot deposition burners 70 and 72. It should be understood that, although FIG. 8 depicts two soot producing burners, more than two burners may be used when practicing the method. Burner apparatus 68 is reciprocally traversed along at least a portion of the length L of core cane 46, wherein burners 70, 72 traverse in both a forward direction, as indicated by arrow F, and a reverse direction as indicated by arrow R. Core cane 46 may rotate in the direction of arrow A or in a direction counter to arrow A. Alternatively, the burners 70 and 72 may be stationary while core cane 46 traverses along a path parallel to the longitudinal axis of core cane 46 and adjacent to the burners. In yet another optional configuration, both burners 70, 72 and core cane 46 may move to create a relative reciprocating motion. A first forward traverse rate of burners 70 and 72 along a length of core cane 46 in the direction of arrow F may be at least about 10 cm/s, preferably at least about 20 cm/s, more preferably at least about 30 cm/s, even more preferably at least about 45 cm/s, and most preferably at least about 55 cm/s. The first forward traverse rate may be as high as 100 cm/s. Preferably, a reverse traverse rate by burners 70, 72 along a length of core cane 46 in the direction of arrow R is greater than the first forward traverse rate. For example, when the first forward traverse rate is between about 10 cm/s and 30 cm/s, the reverse traverse rate may be at least about 40 cm/s.

In yet another embodiment, multiple soot depositing burners 70, 72 are traversed at a first forward traverse rate for a period of time sufficient to deposit an insulating layer 48 of glass soot onto the surface of core cane 46. Preferably, the first forward traverse rate along core cane 46 in direction F is greater than a conventional rate of 3-6 cm/s. Preferably the first forward traverse rate is at least about 10 cm/s, more preferably at least about 20 cm/s, more preferably still at least about 30 cm/s, even more preferably at least about 45 cm/s, and most preferably at least about 55 cm/s. The first forward traverse rate may be as high as about 100 cm/s. Preferably, the reverse traverse rate along core cane 46 in the direction of arrow R is greater than the first forward traverse rate. For example, if the first forward traverse rate is between about 10 cm/s and 30 cm/s, the reverse traverse rate may be at least about 15 cm/s. If the first forward traverse rate is 45 cm/s, the reverse traverse rate is at least about 40 cm/s. Preferably, the reverse traverse rate is at least about 50 cm/s.

Preferably, soot region 48 has a thickness t at least about 5 mm thick, more preferably at least about 7 mm thick, and most preferably at least about 10 mm thick. Soot layer 48 preferably includes a thickness of no more than about 20 mm of soot. Once insulating soot layer 48 has reached a predetermined thickness, the first forward traverse rate may be decreased to a second forward traverse rate in direction F. Preferably, the second forward traverse rate is less than the first forward traverse rate, more preferably the second forward traverse rate is less than about 10 cm/s. A second soot layer 66 is then deposited at the second forward traverse rate to a desired thickness. Preferably, the additional soot layer 66 is deposited on the first, insulating soot layer 48 without sintering either soot layer 48 or soot layer 66.

In another embodiment, as shown in FIG. 9, a single soot depositing burner 20 is used to deposit insulating layer 48 of glass soot onto core cane 46 at a first forward traverse rate. Burner 20 is traversed at a first forward traverse rate for a period of time sufficient to deposit insulating layer 48 of glass soot onto the surface of core cane 46, after which burner 20 is removed and preferably shut down. Preferably, the first forward traverse rate of burner 20 is greater than a conventional rate of 3-6 cm/s. Preferably the first forward traverse rate of burner 20 is at least about 7 cm/s, more preferably at least about 10 cm/s, more preferably still at least about 20 cm/s, even more preferably at least about 30 cm/s, and most preferably at least about 40 cm/s. The forward traverse rate may be as high as about 100 cm/s. Preferably, the reverse traverse rate is greater than the first forward traverse rate. For example, if the first forward traverse rate is at least 10 cm/s, the reverse traverse rate may be at least about 15 cm/s. If the first forward traverse rate is 45 cm/s, the reverse traverse rate is at least about 47 cm/s. Preferably, the reverse traverse rate of burner 20 is at least about 50 cm/s.

Once insulating layer 48 of glass soot has been deposited, multiple burners 70, 72 may be used to deposit an additional soot layer 66 overtop soot layer 48. Preferably, the additional soot layer 66 is deposited overtop the first, insulating soot layer 48 without sintering either soot layer 48 or soot layer 66. Preferably, the thickness t of soot layer 48 at the transition between single burner deposition and multiple burner deposition is at least about 5 mm, more preferably at least about 7 mm, and most preferably at least about 10 mm. The insulating layer 48 of glass soot preferably includes a thickness t of no more than about 20 mm of soot. The transition from single burner deposition to multiple burner deposition may be optionally conducted by, for example, traversing multiple burners, such as 70, 72 throughout the deposition process, but having only burner 70 lighted during the deposition of the insulating soot layer 48. Once insulating layer 48 of glass soot has been deposited by soot depositing burner 70, burner 72 is lighted and the additional soot layer 66 is deposited by both burners 70 and 72. In an alternate embodiment, multiple burners may be traversed throughout the deposition process, wherein soot depositing burner 70 is directed toward the glass rod during deposition of the insulating layer 48 and burner 72 is directed away from glass rod 46. After insulating layer 48 of glass soot is deposited, burner 72 is directed toward glass rod 46, wherein both burners 70 and 72 deposit soot onto glass rod 46. In the embodiment, the forward traverse rate of the burners is greater during the deposition of insulating layer 48 of glass soot than the forward traverse rate of the burners during the deposition of the additional glass soot layer 66. In other words, the deposition of glass soot is divided into a first and second regime, the first regime differing from the second regime by at least the forward burner traverse rate. In the first regime, a first forward traverse rate is used to deposit soot layer 48 onto the surface of glass rod 46 until soot layer 48 has reached a thickness t preferably at least about 5 mm, more preferably at least about 7 mm, and most preferably at least about 10 mm. Preferably, the insulating layer 48 of glass soot is no more than about 20 mm thick. In the second regime, if, once soot region 48 has been deposited onto core cane 46, additional soot layer 66 is desired to be deposited, it is preferred that additional soot layer 66 be deposited in accordance with conventional techniques. For example, the additional soot may be deposited with a plurality of burners at a second forward traverse rate of less than about 10 cm/s. Preferably, the additional soot layer 66 is deposited on the first, insulating soot layer 48 without sintering either soot layer 48 or soot layer 66.

In accordance with a further embodiment of the invention, soot is preferably not deposited onto core cane 46 during the reverse traverse. One technique to avoid depositing soot onto cane 46 during the reverse traverse of burners 70, 72 is to move burner 70 or 72, respectively, out of alignment with core cane 46 during the reverse traverse. In a second technique, the flame of burner 70 or 72 is turned off during the reverse traverse. In another alternate embodiment, second burner 72 is operated under conditions such that the temperature of the flame of burner 72 is less than the temperature of the flame of burner 70.

In another embodiment of the invention, the inventors herein have discovered that the diameter of core cane 46 can affect the concentration of water adsorbed into the glass. It has been discovered by the inventors herein that a larger glass rod diameter will reduce the amount of water in the resultant optical fiber. This is counter to the intuitive assumption that a larger surface area resulting from an increased diameter would increase the concentration of water. Therefore, it is preferred that core cane 46 has a diameter of at least about 28 mm, more preferably at least about 30 mm, more preferably at least about 32 mm, and most preferably at least about 34 mm.

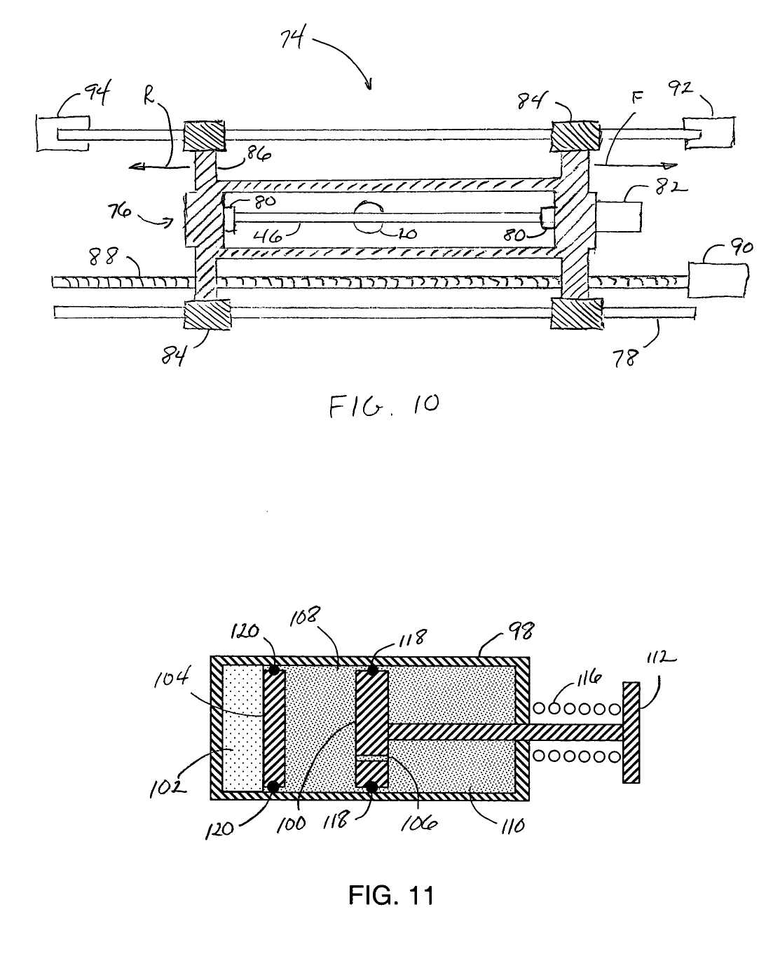

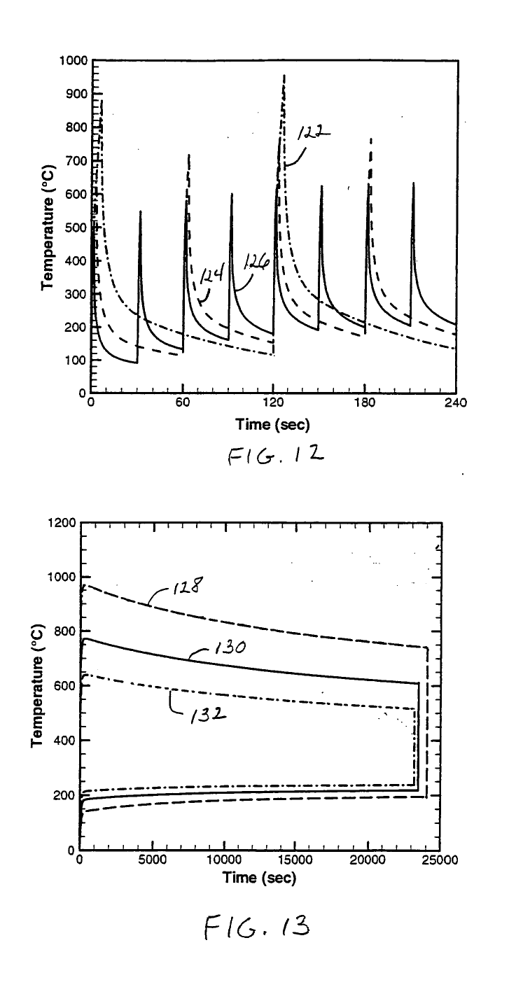

The rapid forward and reverse traverse rates which may be employed during the deposition process may impart considerable wear on the moving elements responsible for the traverse of the components included in the deposition apparatus, particularly at the turnaround points, because of rapid acceleration and deceleration thereat. By turnaround point we mean the point or points at which moving elements of a deposition apparatus change their direction of motion. This consideration is directed primarily at translational movement of the deposition burner or burners, movement of the core cane, or movement of both the burner or burners and the core cane, wherein a reciprocating relative motion is developed between the burner or burners and the core cane. That is, the point or points at which the reciprocating motion of either the burner or burners, and/or the core cane changes direction. Illustrated in FIG. 10 is a deposition lathe 74 having carriage 76 mounted for reciprocating motion on guide rods 78. In the embodiment depicted in FIG. 10, relative motion between burner 20 and core cane 46 is provided by traversing core cane 46 relative to burner 20. Carriage 76 includes chucks 80 for mounting core cane 46 to carriage 76 and a motor 82 for rotating core cane 46. Carriage 76 is connected to guide rods 78 by linear bearings 84 located at the ends of carriage arms 86. Carriage 76 cooperates with lead screw 88 such that rotation of lead screw 88 results in linear motion of carriage 76 along guide rods 78. Referring to FIG. 10, carriage 76 moves in a forward direction, as indicated by arrow F, and in a reverse direction as indicated by arrow R. The direction of travel and speed of travel of carriage 76 along guide rods 78 depends upon the direction of rotation and rotational speed of motor 90 connected to lead screw 88. Damping devices 92 and 94 may be installed at or near each respective turnaround point of carriage 76. Preferably, damping devices 92 or 94 functions at least as a damping device, more preferably as both a damping and an accelerating device, for carriage 76 as carriage 76 reaches a turnaround point. Examples of suitable damping devices 92 or 94 include a spring or a shock absorber. The design of such damping devices are well known in the art. One potential supplier of shock absorbers is Enertrols Inc. of Westland, Mich. The invention does not require a damping device at each turnaround point. For example lathe 74 may include damping device 92, 94 at only one of the turnaround points. FIG. 11 illustrates an example of a damping device. Damping device 92 (94) as shown in FIG. 11 includes a housing 98 and a piston 100 slidably disposed within the housing. Housing 98 preferably also includes an accumulator chamber 102 formed between a portion of housing 98 and movable barrier 104, barrier 104 being slidably disposed within housing 98. Optionally, barrier 104 may be a flexible diaphragm. The space between housing 98 and barrier 104 contains a compressible fluid, such as a gas. Accumulator chamber 102 may include a flexible bladder containing a compressible fluid. Accumulator chamber 102 may be located remotely from housing 98 and connected to housing 98 by a passage wherein accumulator chamber 102 is in fluid communication with housing 98. Piston 100 is perforated by at least one passage 106, wherein a first chamber 108 is in fluid communication with second chamber 110 through passage 106. Chambers 108 and 110 contain a viscous fluid suitable for hydraulic or pneumatic cooperation with piston 100. The fluid may be a liquid, such as an oil, or a gas, optionally the fluid may be a magnetorheological fluid. Preferably, the fluid is an oil. Piston 100 is connected to bumper 112 by piston shaft 114. Spring 116 acts against bumper 112 to extend bumper 112 away from housing 98. Preferably, damping device 92, 94 is capable of evenly dissipating the kinetic energy of reciprocating carriage 76. In the embodiment shown in FIG. 11, linear movement of carriage 76 (shown in FIG. 10) causes carriage 76, or an attachment to carriage 76, to contact bumper 108, causing piston 100 to travel through housing 98 and the viscous fluid. Seal 118 prevents the flow of viscous fluid past the rim of piston 100. An additional seal 120 is located at the periphery of barrier 104. Seals 118 and 120 may be O-rings, for example. Flow of the viscous fluid between chambers 108 and 110 is restricted by passage 106 such that the fluid provides a damping force to the movement of piston 100 through housing 98 and the viscous fluid. The kinetic energy of carriage 76 is dissipated as heat within the viscous fluid, causing carriage 76 to decelerate. As piston 100 is driven into housing 98 by carriage 76, spring 116 is compressed by bumper 112, storing kinetic energy from carriage 74 in spring 116. At the turnaround point, motor 90 reverses rotational direction, causing lead screw 88 to also reverse direction. Carriage 76 is driven in a second direction opposite to the first direction of carriage 76. The kinetic energy from carriage 74 which was stored in spring 116 is released, providing an return force to bumper 112, causing piston 100 and bumper 112 to reverse direction and act against carriage 76, thereby assisting motor 90 in accelerating carriage 76 and resetting damping element 92. Optionally, relative motion may be provided by traversing burner 20, wherein damping device 92, 94 would be suitably employed to decelerate or accelerate burner 20.

It is preferred that damping device 92 or 94 will assist in slowing down carriage 76 approximately immediately prior to each respective turn around point. It is further preferred that damping device 92 or 94 assists in the acceleration of carriage 76 approximately immediately subsequent to each turn around point.

The above embodiment of lathe 74 is particularly useful when operating carriage 76, (or alternatively, burner 20) at forward traverse rates of at least about 7 cm/s, preferably more than at least 10 cm/s, more preferably at least about 20 cm/s, even more preferably at least about 30 cm/s, and most preferably at least about 40 cm/s. The same is true with respect to burner apparatus 68 depicted in FIG. 8.

In a further embodiment of the invention, a non-hydrogen containing fuel, CO, or a plasma flame, is used to deposit insulating layer 48 of soot in accordance with FIG. 7. Once insulating layer 48 has been deposited with a predetermined thickness of at least about 5 mm and up to about 20 mm of glass soot, a hydrogen-containing fuel, e.g. H₂ or a hydrocarbon, may be used to deposit additional soot layer 66 onto soot layer 48. Additional glass soot layer 66 may be deposited with one or more burners.

The invention will be further clarified by the following examples.

### EXAMPLES

### Example 1

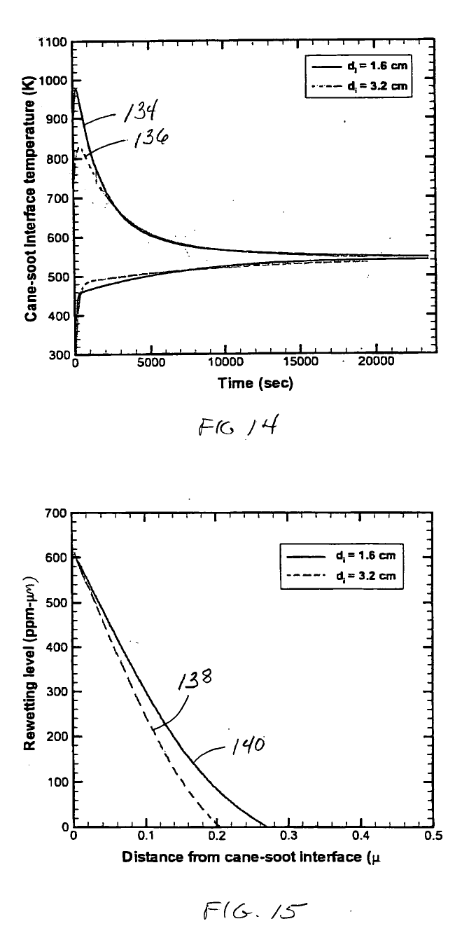

FIG. 12 shows the calculated effect on surface temperature of a single burner traversing adjacent to and parallel with the longitudinal axis of a glass rod during the deposition of glass soot onto the rod. The data show temperature vs. time for the first few forward traverses of the burner flame. The forward traverse rate of the burner was evaluated for three traversing conditions; 30 seconds/pass, shown by curve 122, 60 seconds/pass, shown by curve 124, and 120 seconds/pass as indicated by curve 126. The time required for a pass is interpreted as the time between the burner flame passing a given point on the glass rod during one forward traverse to the time the flame passed the same point during the next forward traverse. The figure shows that the calculated peak temperature varies from between about 550° C. to 640° C. for the 30 second/pass rate, between about 660° C. and 780° C. for the 60 second/pass rate and between about 890° C. and 960° C. for the 120 seconds/pass rate. FIG. 13 illustrates the calculated overall temperature envelope as a function of time for the entire deposition process, and shows an increasing overall temperature as a function of time for a decreasing traverse rate (increasing seconds/pass). Shown in FIG. 13 are calculated temperature envelopes for a single deposition burner traversing at 30 seconds/pass (128), 60 seconds/pass (130), and 120 seconds/pass (132). FIG. 11 also shows that as deposition progresses, and the glass soot layer becomes thicker, the temperature at the surface of the glass rod decreases because of the formation of the insulating glass soot layer.

### Example 2

FIG. 14 depicts the temperature envelope as a function of time during a deposition of glass soot for two rods, a first glass rod having a diameter of about 1.6 cm, as indicated by curve 134, and a second glass rod having a diameter of about 3.2 cm as indicated by dashed curve 136. (As noted above, the temperature envelope encompasses and defines the maximum and minimum temperatures during each pass of a traversing burner or burners during the deposition process.) The same mass of soot was deposited onto each glass rod. The final diameter of the first glass rod was about 4 cm, and the final diameter of the second glass rod was about 4.866 cm. During the deposition of soot, the temperature of the deposition surface of each soot preform was monitored by optical pyrometer. FIG. 14 shows that a glass rod having a large diameter has a lower peak surface temperature for each pass of the burner, and therefore a lower overall temperature envelope, than a glass rod having a smaller diameter. The temperature decreases over time as the deposition process progresses, indicating an increasingly thicker glass soot layer on the surface of the glass rod.

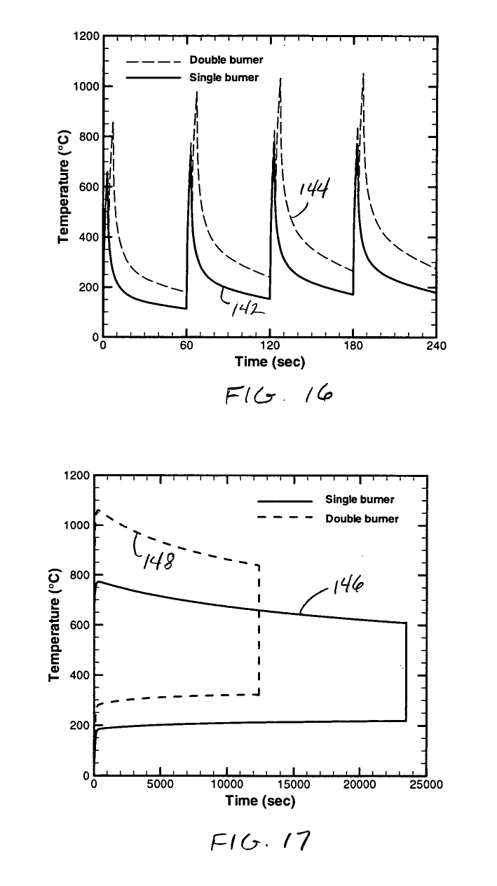

The data in FIG. 15 show the level of water adsorbed into the glass rod surface (in ppm-μm) as a function of radial distance from the surface for the two glass rods depicted in FIG. 14. An analysis utilizing Fourier transform in the infrared (FTIR) was used to determine the water concentration at various radial distances along the preform extending from the glass surface-soot interface. Although both glass rods are shown having the same total concentration of water at the surface of the glass rod, the concentration of water diverges as the adsorption depth into the glass rod increases. The 3.2 cm diameter glass rod (138) is shown having a lower water content than the 1.6 cm diameter glass rod (140) for the same adsorption depth. For example, at a depth of approximately 0.2 μm, the 3.2 cm diameter glass rod has a virtually undetectable concentration of water, while the 1.6 cm diameter glass rod has a concentration of about 100 ppm-μm water. Thus, the larger diameter is advantageous for reducing the amount of water imported into the rod from the deposition process.

### Example 3

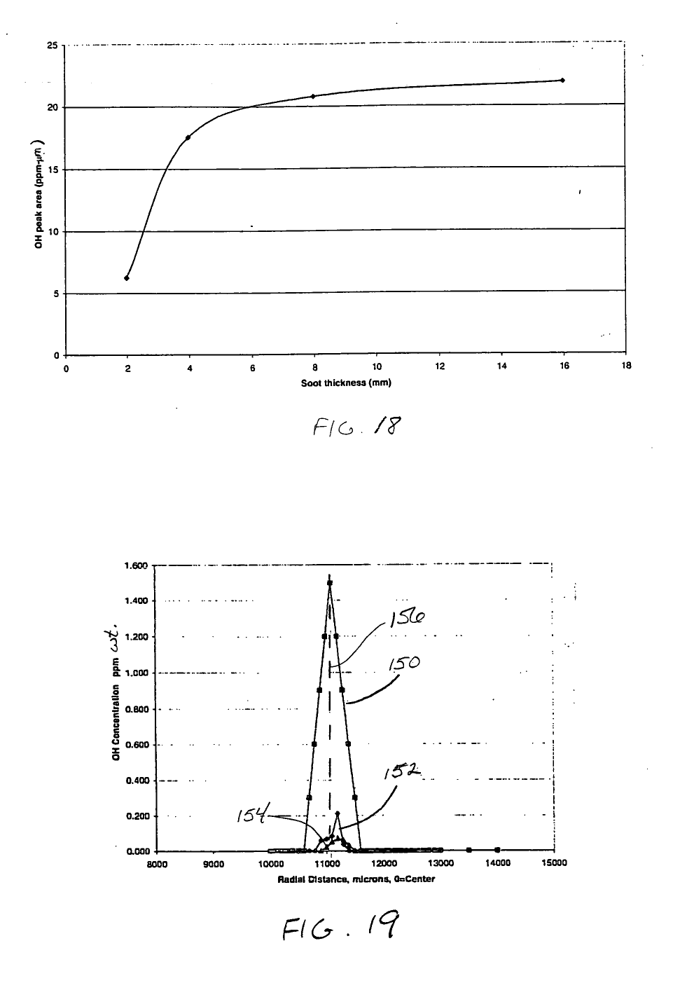

FIG. 16 shows a comparison between deposition with a single-burner and deposition using two burners. Both burner arrangements of FIG. 16 had a traverse cycle of 60 seconds/traverse. According to FIG. 16, the single burner data 142 displayed a maximum calculated temperature of about 800° C., while the two-burner data 144 had a maximum calculated temperature of about 1000° C. FIG. 17 depicts the overall temperature envelope as a function of time for the single burner case compared with a two burner configuration throughout a deposition process (i.e. many thousands of passes). The overall temperature envelope 148 of the two-burner configuration has a higher maximum temperature than the envelope 146 for a single burner configuration. Therefore, the use of two burners to deposit soot would be expected to produce a higher attenuation due to the adsorption of water than the use of a single burner. The figure shows an increased temperature for the use of two burners. FIG. 17 also indicates a decreasing temperature for both single-burner deposition and two-burner deposition, indicating an increasing thickness of deposited glass soot on the surface of the glass rod. The increasing thickness of glass soot serves to provide an insulating layer to the glass rod, thereby reducing the temperature of the glass rod surface, i.e. at the interface between the glass rod and the deposited soot. This decreased temperature may result in a reduction of adsorbed water content in the glass rod.

### Example 4

FIG. 18 graphically illustrates the concentration of water in ppm (by weight)-μm in a glass rod upon which a layer of glass soot has been deposited. The figure shows that as the thickness of the soot layer increases, the amount of water adsorbed into the surface of the glass decreases. Note that the decrease is not linear, and that after a relatively thin layer of soot has been deposited, for example, 20 mm, the concentration of water adsorbed into the glass rod reaches a generally constant level. The data indicate that after a soot thickness of about 5 mm the reduction in adsorbed water begins to level, and after a soot thickness of about 20 mm has been deposited, the concentration of water does not change appreciably. The data were collected by performing FTIR analysis on a series of glass rods after varying thicknesses of soot had been deposited The rods were cut to expose a radial profile, and the radial profile was analyzed to determine the amount of water contained within the glass.

### Example 5

FIG. 19 shows the OH concentration, in ppm by weight, in three optical fiber preforms. The three optical fiber preforms were manufactured using three, substantially identical core canes. The core canes were manufactured by convention methods, and then overclad with silica soot, using varying traverse rates, to form composite preforms. The composite preforms were consolidated, and then cut perpendicular to the longitudinal axis of the preforms to facilitate meansurement of the preforms. The data represented by curve 150 represents a deposition of glass soot onto a core cane using two soot producing burners at a forward traverse rate of 1.66 cm/s. Curve 152 represents a deposition of glass soot at a forward traverse rate of 10 cm/s using two soot producing burners. Curve 154 represents the deposition of soot using a single soot producing burner at a forward traverse rate of 1.66 cm/s. FIG. 19 shows that, for a dual-burner deposition process, increasing the forward traverse rate by at least 4 times resulted in a significant reduction in the amount of water (in this instance OH), within the consolidated glass cane. Also shown by FIG. 19 is a peak amount of OH at the surface of the core cane of about 0.200 ppm for the case where a fast forward traverse was used, as indicated by curve 152, and wherein the amount of OH at the interface of the core cane-soot, as defined herein (i.e. within 100 μm of the surface of the core cane), is less than 0.200 ppm. In FIG. 19, line 156 represents the glass core cane-overclad interface. In this example, a first insulating layer of soot was not deposited.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. A method for making an optical fiber preform comprising the steps of:
providing relative reciprocating motion between at least one soot producing burner and a consolidated glass rod;
depositing a first layer of glass soot along a length of the consolidated glass rod at a first traverse rate in a first direction;
depositing a second layer of glass soot onto the first layer of glass soot at a second traverse rate in the first direction without sintering; and
wherein the first traverse rate is greater than the second traverse rate.

2. The method according to claim 1 wherein the first traverse rate is at least about 7 cm/s.

3. The method according to claim 2 wherein the first traverse rate is at least about 10 cm/s.

4. The method according to claim 1 wherein a thickness of the first layer of glass soot is at least about 5 mm.

5. The method according to claim 4 wherein the thickness of the first layer of glass soot is between about 5 mm and 20 mm.

6. The method according to claim 1 wherein a traverse rate in a second direction opposite the first direction is greater than the first traverse rate in the first direction.

7. The method according to claim 6 wherein a deposition rate during a traverse in the second direction is substantially zero.

8. The method according to claim 1 wherein the step of depositing a second layer of glass soot comprises depositing soot with at least two soot deposition burners.

9. The method according to claim 8 further comprising operating the at least two burners under conditions such that a temperature of a flame of a second burner of the at least two burners is less than a temperature of a flame of a first burner of the at least two burners.

10. The method according to claim 1 wherein the step of depositing the first layer of glass soot comprises combusting a fuel, wherein the fuel is substantially free of hydrogen.

11. The method according to claim 1 wherein the step of depositing the first layer of glass soot comprises depositing soot onto a glass rod having a diameter of at least about 28 mm.

12. The method according to claim 11 wherein the step of depositing the first layer of glass soot comprises depositing soot onto a glass rod having a diameter of at least about 32 mm.

13. The method according to claim 1 wherein the step of providing relative reciprocating motion comprises attaching the glass rod to a movable support and traversing the movable support relative to the at least one burner.

14. The method according to claim 13 further comprising applying a damping force to a movement of the movable support at a turnaround point by moving a piston through a viscous fluid.

15. An apparatus for depositing soot onto a glass rod comprising:
at least one glass soot producing burner;
a movable support for mounting a glass rod; and
at least one damping device comprising a piston and a viscous fluid mounted for cooperation with the support and aligned to inhibit a movement of the support at a first turnaround point.

16. The apparatus according to claim 15 wherein the damping element stores kinetic energy from the movable support and then releases it at about the turnaround point.
